(19) United States
(12) Patent Application Publication
(10) Pub. No.: US 2023/0297465 A1
(43) Pub. Date: Sep. 21, 2023

(54) DETECTING SILENT DATA CORRUPTIONS WITHIN A LARGE SCALE INFRASTRUCTURE

(71) Applicant: META PLATFORMS, INC., Menlo Park, CA (US)

(72) Inventors: Harish Dattatraya Dixit, Mountain View, CA (US); Sriram Sankar, Fremont, CA (US); Matthew David Beadon, San Jose, CA (US); Gautham Venkat Vunnam, Menlo Park, CA (US); Laura Ann Boyle, Oranmore (IE)

(73) Assignee: META PLATFORMS, INC., Menlo Park, CA (US)

(21) Appl. No.: 18/054,803

(22) Filed: Nov. 11, 2022

Related U.S. Application Data
(60) Provisional application No. 63/319,985, filed on Mar. 15, 2022.

(51) Int. Cl. G06F 11/07

(52) U.S. Cl. CPC G06F 11/0793; G06F 11/079; G06F 11/0709

(57) ABSTRACT

Systems, apparatuses and methods provide technology for conducting silent data corruption (SDC) testing in a network including a fleet of production servers comprising generating a first SDC test selected from a repository of SDC tests, submitting the first SDC test for execution on a plurality of servers selected from the fleet of production servers, wherein for each respective server of the plurality of servers the first SDC test is executed as a test workload in co-location with a production workload executed on the respective server, determining a result of the first SDC test performed on a first server of the plurality of servers, and upon determining that the result of the first SDC test performed on the first server is a test failure, removing the first server from a production status, and entering the first server in a quarantine process to investigate and to mitigate the test failure.

### CROSS REFERENCE TO RELATED APPLICATION(S)

This application claims the benefit of U.S. Provisional Patent Application Ser. No. 63/319,985 entitled “Detecting Silent Data Corruptions in the Wild,” filed on Mar. 15, 2022, which is incorporated herein by reference in its entirety.

### TECHNICAL FIELD

Examples generally relate to computing systems. More particularly, examples relate to detecting errors within a large scale computing infrastructure.

### BACKGROUND

Silent data corruptions (SDCs) in hardware impact computational integrity for large-scale applications. Silent data corruptions, or silent errors, can occur within hardware devices when an internal defect manifests in a part of the circuit which does not have check logic to detect the incorrect circuit operation. The results of such a defect can range from flipping a single bit in a single data value up to causing the software to execute the wrong instructions. Manifestations of silent data corruptions are accelerated by datapath variations, temperature variance, and age—among other silicon factors. These errors do not leave any record or trace in system logs. As a result, silent data corruptions stay undetected within workloads, and their effects can propagate across several services, causing problems to appear in systems far removed from the original defect.

This potential for propagation of SDC effects is exacerbated in large computing infrastructure environments containing thousands or potentially millions of devices servicing millions of users over an extended geographical reach. Thus, detecting silent data corruption is a particularly challenging problem for large scale infrastructures. Applications show significant sensitivity to these problems and can be exposed to such corruptions for months without accelerated detection mechanisms, and the impact of silent data corruptions can have a cascading effect through and across applications. SDCs can also result in data loss and require months to debug and resolve software level residue of silent corruptions.

### SUMMARY OF PARTICULAR EXAMPLES

In some examples, a computer-implemented method of conducting silent data corruption (SDC) testing in a network having a test controller and a fleet of production servers includes generating a first SDC test selected from a repository of SDC tests, submitting the first SDC test for execution on a plurality of servers selected from the fleet of production servers, where for each of the plurality of servers the first SDC test is executed as a test workload in co-location with a production workload executed on the respective server, determining a result of the first SDC test performed on a first server of the plurality of servers, and upon determining that the result of the first SDC test performed on the first server is a test failure, removing the first server from a production status, and entering the first server in a quarantine process to investigate and to mitigate the test failure.

In some examples, at least one computer readable storage medium includes a set of instructions which, when executed by a computing device in a network having a fleet of production servers, cause the computing device to perform operations comprising generating a first SDC test selected from a repository of SDC tests, submitting the first SDC test for execution on a plurality of servers selected from the fleet of production servers, and where for each of the plurality of servers the first SDC test is executed as a test workload in co-location with a production workload executed on the respective server, determining results of the first SDC test performed on a first server of the plurality of servers, and upon determining that the results of the first SDC test performed on the first server is a test failure, removing the first production server from a production status, and entering the first production server in a quarantine process to investigate and to mitigate the test failure.

In some examples, a computing system configured for operation in a network having a fleet of production servers includes a processor, and a memory coupled to the processor, the memory including instructions which, when executed by the processor, cause the computing system to perform operations comprising generating a first SDC test selected from a repository of SDC tests, submitting the first SDC test for execution on a plurality of servers selected from the fleet of production servers, and where for each of the plurality of servers the first SDC test is executed as a test workload in co-location with a production workload executed on the respective server, determining results of the first SDC test performed on a first server of the plurality of servers, and upon determining that the results of the first SDC test performed on the first server is a test failure, removing the first production server from a production status, and entering the first production server in a quarantine process to investigate and to mitigate the test failure.

The examples disclosed above are only examples, and the scope of this disclosure is not limited to them. Particular examples may include all, some, or none of the components, elements, features, functions, operations, or steps of the examples disclosed above. Examples according to the invention are in particular disclosed in the attached claims directed to a method, a storage medium, and a system, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the examples and features described or depicted herein can be claimed in a separate claim and/or in any combination with any example or feature described or depicted herein or with any of the features of the attached claims.

### BRIEF DESCRIPTION OF THE DRAWINGS

The various advantages of the examples of the present disclosure will become apparent to one skilled in the art by reading the following specification and appended claims, and by referencing the following drawings, in which:

FIG. 1 is a block diagram illustrating an example of a networked infrastructure environment for detecting silent data corruptions according to one or more examples;

FIG. 2 is a diagram illustrating various stages in which device testing can occur, including out-of-production and in-production stages according to one or more examples;

FIG. 3 is a diagram illustrating an example of out-of-production testing according to one or more examples;

FIG. 4 is a diagram illustrating an example of in-production testing according to one or more examples;

FIG. 5 is a block diagram of an example of an architecture for a test controller according to one or more examples;

FIG. 6 is a diagram illustrating an example of a quarantine process to investigate and mitigate test failures according to one or more examples;

FIG. 7 is a diagram illustrating an example of shadow testing according to one or more examples;

FIGS. 8A-8D provide flow charts illustrating an example method of conducting silent data corruption (SDC) testing according to one or more examples; and

FIG. 9 is a block diagram illustrating a computing system for use in a silent data corruption detection system according to one or more examples.

### DETAILED DESCRIPTION

The technology as described herein provides an improved computing system using testing strategies and methodologies to detect silent data corruptions within a large scale computing infrastructure. These testing strategies and methodologies focus on silent data corruption (SDC) detection in machines within a large scale computing infrastructure that are in-production (i.e., machines that are actively performing production workloads), or out-of-production (i.e., machines that are in, or entering, a maintenance phase). The technology helps improve the overall reliability and performance of large scale computing by detecting machines subject to SDCs and moving them into a quarantine environment to investigate the cause and mitigate the problem before errors propagate across services and systems.

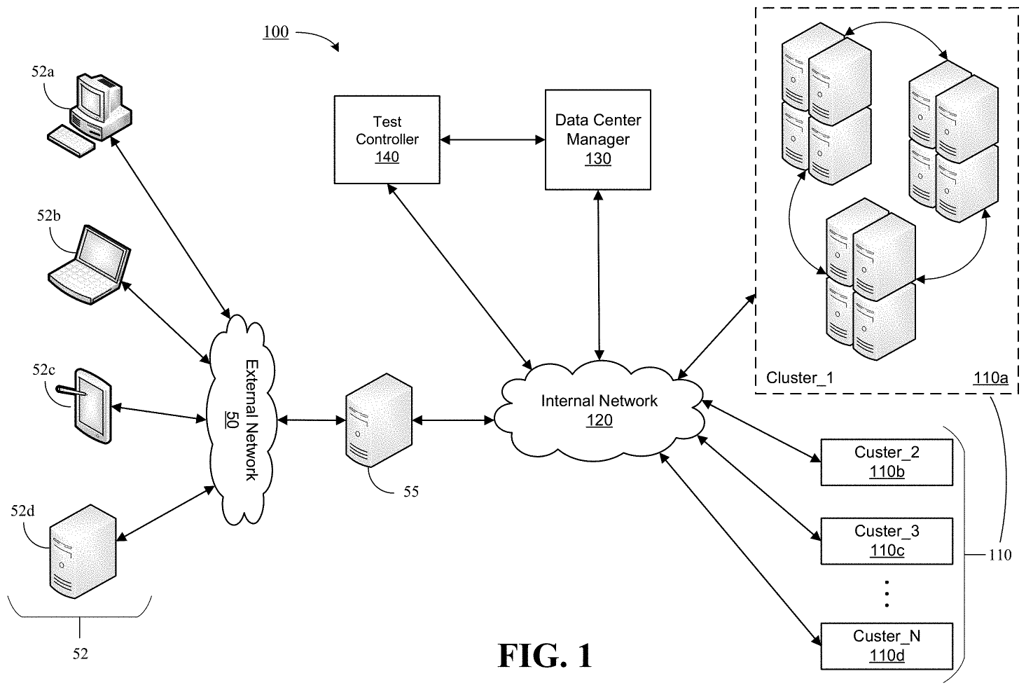

FIG. 1 provides a block diagram illustrating an example of a networked infrastructure environment 100 for detecting silent data corruptions according to one or more examples, with reference to components and features described herein including but not limited to the figures and associated description. As shown in FIG. 1, the networked infrastructure environment 100 includes an external network 50, a plurality of user or client devices 52 (such as example client devices 52a-52d), a network server 55, a plurality of server clusters 110 (such as example clusters 110a-110d), an internal network 120, a data center manager 130, and a test controller 140. The external network 50 is a public (or public-facing) network, such as the Internet. The client devices 52a-52d are devices that communicate over a computer network (such as the Internet) and can include devices such as a desktop computer, laptop computer, tablet, etc. The client devices 52a-52d can operate in a networked environment and run application software, such as a web browser, to facilitate networked communications and interaction with other remote computing systems, including one or more servers, using logical connections via the external network 50.

The network server 55 is a computing device that operates to provide communication and facilitate interactive services between users (such as via client devices 52a-52d) and services hosted within a networked infrastructure via other servers, such as servers in clusters. For example, the network server 55 can operate as an edge server or a web server. In some examples, the network server 55 is representative of a set of servers that can range in the tens, hundreds or thousands of servers. The networked services can include services and applications provided to thousands, hundreds of thousands or even millions of users, including, e.g., social media, social networking, media and content, communications, banking and financial services, virtual/augmented reality, etc.

The networked services can be hosted via servers, which in some examples can be grouped in one or more server clusters 110 such as, e.g., one or more of Cluster_1 (110a), Cluster_2 (110b), Cluster_3 (110c) through Cluster N (110d). The servers/clusters are sometimes referred to herein as fleet servers or fleet computing devices. Each server cluster 110 corresponds to a group of servers that can range in the tens, hundreds or thousands of servers. In some examples, a fleet can include millions of servers and other devices spread across multiple regions and fault domains. In some examples, each of these servers can share a database or can have their own database (not shown in FIG. 1) that warehouse (e.g. store) information. Server clusters and databases can each be a distributed computing environment encompassing multiple computing devices, and can be located at the same or at geographically disparate physical locations. Fleet servers, such as the servers in clusters 110, can be networked via the internal network 120 (which can include an infrastructure/backbone network) and managed via a data center manager 130.

Networked services such as those identified herein are provided with the expectation of a degree of computational integrity and reliability from the underlying infrastructure. Silent data corruptions challenge this assumption and can impact services and applications at scale. To help address the problem of SDCs, the test controller 140 is provided that interacts with one or more servers in the server clusters 110 via, e.g., the data center manager 130 and/or the internal network 120. The test controller 140 operates to generate and schedule tests designed to detect silent data corruptions that may occur in servers within the networked environment, such as the servers in the server clusters 110. The test controller 140 also operates to receive results of the testing, identify failures, and place failed servers in a quarantine process to investigate and mitigate test failures. As described in further detail herein, testing performed by the test controller 140 falls within two stages or phases: out-of-production testing, to test devices entering a maintenance phase, and in-production testing, to test devices while actively performing production services.

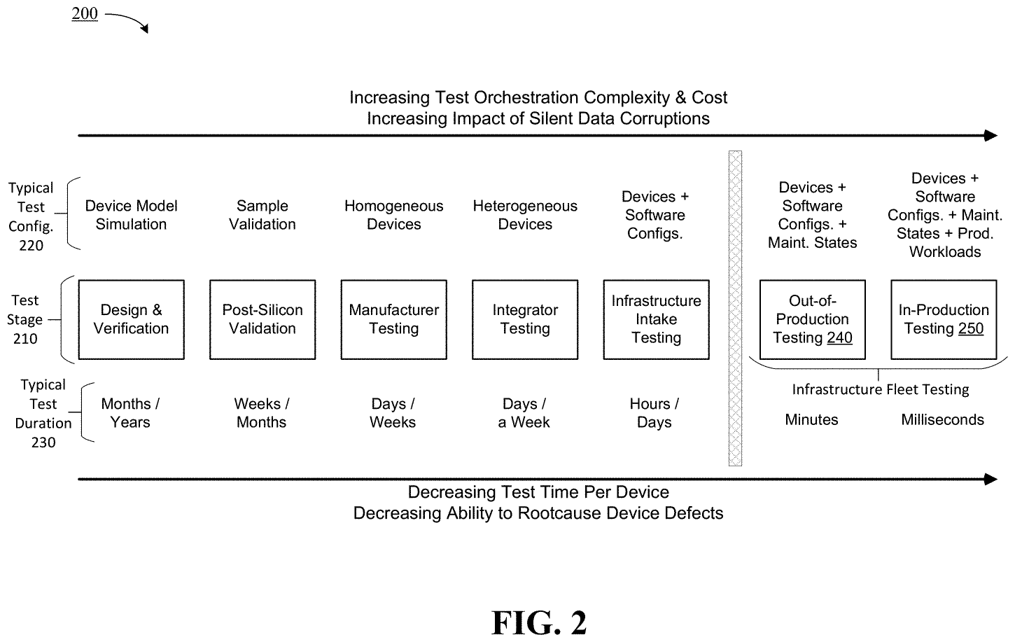

FIG. 2 is a diagram 200 illustrating various stages in which device testing can occur, including out-of-production and in-production stages according to one or more examples, with reference to components and features described herein including but not limited to the figures and associated description. FIG. 2 includes high-level illustration of various stages 210 in which testing takes place, along with corresponding typical test configurations 220 and corresponding typical test durations 230. As shown in FIG. 2, devices go through several stages of testing as part of the development process before reaching the infrastructure and joining the fleet of computing devices, with testing proceeding typically as summarized below. In general terms, FIG. 2 illustrates that, as the lifecycle advances from design and verification through infrastructure intake testing, and then into infrastructure post-intake testing, the general trend is for increasing test orchestration complexity & cost, with a decreasing test time per device accompanied by a decreasing ability to rootcause device defects. At the same time, the impact of silent data errors is ever-increasing.

Design and Verification.

For silicon devices, once the architectural requirements are finalized, the silicon design and development process is initiated. Testing is usually limited to a few design models of the device, and simulations and emulations are used to test different features of the design models. The device is tested regularly with implementation of novel features. Test iterations are implemented on a daily basis. The cost of testing is low relative to the other stages, and the testing is repeated using different silicon variation models. Design iteration at this stage is faster than any other stage in the process. Faults can be identified based on internal states that are not visible in later stages of the development cycle. The test cost increases slowly with placement of standard cells for ensuring that the device meets the frequency and clock requirements, and also with the addition of different physical characteristics associated with the materials as part of the physical design of the device. The testing process for this stage typically lasts usually for many months to a couple of years depending on the chip and the development stages employed.

Post Silicon Validation.

At this stage, numerous device samples are available for validation. Using the test modes available within the design of the device, the design is validated for different features using the samples. The number of device variations has grown from models in the previous stage to actual physical devices exhibiting manufacturing variance. Significant fabrication costs have been incurred before obtaining the samples, and a device fault at this stage has a higher impact since it typically results in a re-spin for the device. Additionally, there is a larger test cost associated with precise and expensive instrumentation for multiple devices under test. At the end of this validation phase, the silicon device can be considered as approved for mass production. The testing process for this stage typically lasts for a few weeks to a few months.

Manufacturer Testing.

At the mass production stage, every device is subjected to automated test patterns using advanced fixtures. Based on the results of the testing patterns, the devices are binned into different performance groups to account for manufacturing variations. As millions of devices are tested and binned, time allocated for testing has a direct impact on manufacturing throughput. The testing volume has increased from a few devices in the previous stage to millions of devices, and test cost scales per device. Faults are expensive at this stage, as they typically result in respin or remanufacturing of the device. Testing for this stage typically lasts for a period of days to a few weeks.

Integrator Testing.

After the manufacturing and testing phases, the devices are shipped to an end customer. A large scale infrastructure operator typically utilizes an integrator to coordinate the process of rack design, rack integration and server installation. The integrator facility typically conducts testing for multiple sets of racks at once. The complexity of testing at this stage has now increased from one device type to multiple types of devices working together in cohesion. The test cost increases from a single device to testing for multiple configurations and combinations of multiple devices. An integrator typically tests the racks for a few days to a week. Any faults require reassembly of racks and reintegration.

Infrastructure Intake Testing.

As part of the rack intake process, infrastructure teams typically conduct an intake test where the entire rack received from the integrator is wired together with datacenter networks within the designated locations. Subsequently, test applications are executed on the device before executing actual production workloads. In testing terms, this is referred to as infrastructure burn-in testing. Tests are typically executed for a few hours to a couple of days. There are hundreds of racks containing a large number of complex devices that are now paired with complex software application tools and operating systems. The testing complexity at this stage has increased significantly relative to previous test iterations. A fault is challenging to diagnose due to the larger source of fault domain.

Infrastructure Fleet Testing.

Historically, the testing practices concluded at infrastructure burn-in testing (the infrastructure intake stage). Once a device has passed the burn-in stage, the device is expected to work for the rest of its lifecycle; any faults, if observed, would be captured using system health metrics and reliability-availability-serviceability features built into devices, which allow for collecting system health signals.

However, with silent data corruptions, there is no symptom or signal that indicates there is a fault with a device once the device has been installed in the infrastructure fleet. Hence, without running tests (e.g., dedicated test patterns) to detect and triage silent data corruptions, it is almost impossible to protect an infrastructure application from corruption due to silent data errors. At this point within the lifecycle, the device is already part of a rack and serving production workloads. The testing cost is high relative to other stages, as it requires complex orchestration and scheduling while ensuring that the workloads are drained and undrained effectively. Tests are designed to run in complex multi-configuration, multi-workload environments. Any time spent in creating test environments and running the tests is time taken away from server running production workloads. Further, a fault within a production fleet is expensive to triage and rootcause as the fault domains have evolved to be more complex with ever changing software and hardware configurations. Faults can be due to a variety of sources or accelerants, and based on observations can be categorized into four groupings as summarized below.

Data Randomization.

Silent data corruptions are data dependent by nature. For example, in numerous instances the majority of the computations would be fine within a corrupt CPU but a smaller subset would always produce faulty computations due to certain bit pattern representation. For example, it may be observed that 3 times 5 is 15, but 3 times 4 is evaluated to 10. Thus, until and unless 3 times 4 is verified specifically, computation accuracy cannot be confirmed within the device for that specific computation. This results in a fairly large state space for testing.

Electrical Variations.

In a large scale infrastructure, with varying nature of workloads and scheduling algorithms, the devices undergo a variety of operating frequency (f), voltage (V) and current (I) fluctuations. Changing operating voltages, frequency and current associated with the device can lead to acceleration of occurrence of erroneous results on faulty devices. While the result would be accurate with one particular set of f, V and I, the result may not hold true for all possible operating points. For example, 3 times 5 yields 15 in some operating conditions, but repeating the same calculation may not always result in 15 under all operating conditions. This leads to a multi-variate state space.

Environmental Variations.

Variations in location dependent parameters also accelerate occurrence of silent data corruptions. For example, temperature and humidity have a direct impact on the voltage and frequency parameters associated with the device due to device physics. In a large-scale datacenter, while the temperature and humidity variations are controlled to be minimal, there can be occurrences of hot-spots within specific server locations due to the nature of repeated workloads on that server and neighboring servers. Also, the seasonal trends associated with a datacenter location can create hotspots across data halls within a datacenter. For example, 3 times 5 may yield 15 in datacenter A, but repeated computations can result in 3 times 5 computing to 12 in datacenter B.

Lifecycle Variations.

Silicon devices continually change in performance and reliability with time (e.g., following bathtub curve failure modeling). However, with silent data corruptions certain failures can manifest earlier than the traditional bathtub curve predictions based on device usage. As a result, a computation producing a correct result today provides no guarantee that the computation will produce a correct result tomorrow. For example, the exact same computation sequence can be repeated on the device once every day for a period of 6 months, and the device could fail after 6 months, indicating degradation with time for that computation. For example, a computation of 3 times 5 equals 15 can provide a correct result today, but tomorrow may result in 3 times 5 being evaluated to an incorrect value.

Furthermore, with millions of devices, within a large scale infrastructure, there is a probability of error propagation to the applications. With an occurrence rate of one fault within a thousand devices, silent data corruptions potentially can impact numerous applications. Until the application exhibits noticeable difference at higher level metrics, the corruption continues to propagate and produce erroneous computations. This scale of fault propagation presents a significant challenge to a reliable infrastructure.

Accordingly, as described herein, testing for SDCs is performed periodically within the fleet using different, advanced strategies to detect silent data corruptions with expensive infrastructure tradeoffs. The strategy includes periodic testing with dynamic control of tests to triage corruptions and protect applications, to repeatedly test the infrastructure with ever improving test routines and advanced test pattern generation. By building engineering capability in finding hidden patterns across hundreds of failures, and feeding the insights into optimizations for test runtimes, testing policies and architectures, the fleet resiliency can be improved.

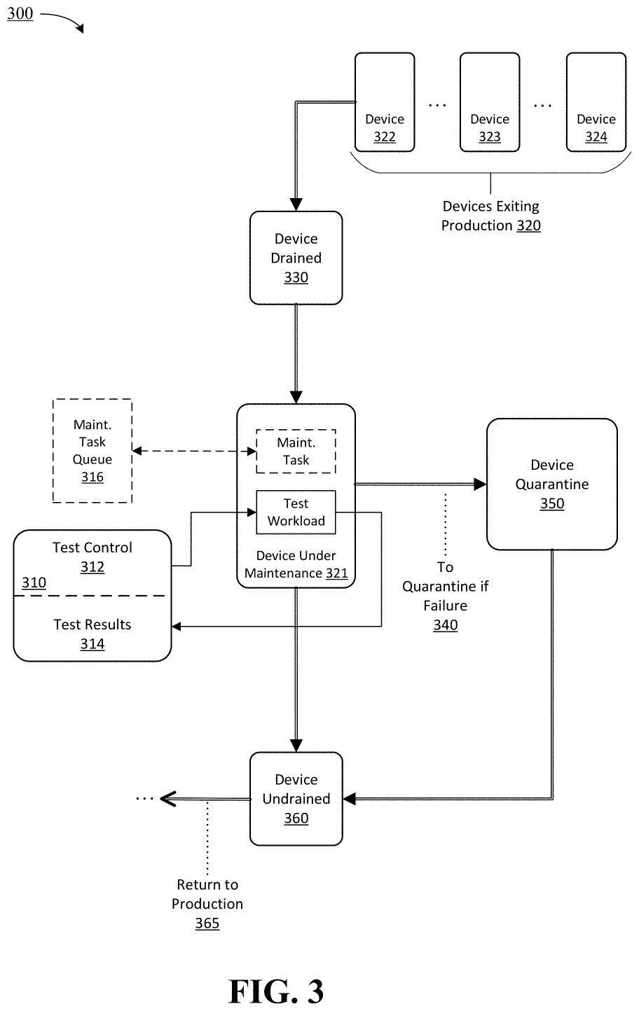

More particularly, according to examples as described herein, the technology involves two main categories of testing of an infrastructure fleet: out-of-production testing, corresponding to the out-of-production testing stage 240 (FIG. 2), and in-production testing, corresponding to the in-production testing stage 250 (FIG. 2). Further details regarding out-of-production testing and in-production testing are provided below and herein with reference to FIGS. 3, 4, 5, 6, 7, and 8A-8D.

Out-of-production testing refers to conducting SDC tests on devices that are idle and not executing production workloads—typically, such devices are entering or undergoing a maintenance phase—while remaining within the networked infrastructure environment. In this way, out-of-production testing allows for testing opportunistically when machines transition across states. Out-of-production testing involves consideration not only of specific devices but also software configuration of the devices and systems, along with maintenance states (including types of maintenance tasks to be performed). Given constraints on machines exiting production for maintenance, SDC testing for out-of-production machines typically ranges in minutes of duration.

In-production testing refers to conducting SDC tests on devices in the networked infrastructure environment that are actively performing production workloads. This enables more rapid testing through the fleet where a novel test signature is identified and must be quickly scaled to the entire fleet; in such instances, waiting for out-of-production scanning opportunities and subsequently ramping up fleetwide coverage is slower. For example, a novel signature identified within the fleet for a device could be scaled to the entire fleet with satisfiable test randomization and defect pattern matching within a couple of weeks. In addition to the considerations involved with out-of-production testing, for in-production testing the nature of production workloads that are being executed along with the test workloads must also be taken into consideration. A granular understanding of the production workloads is required, along with modulation of testing routines with the workloads. Compared to out-of-production testing, SDC testing for in-production machines is of a shorter duration, typically on the order of milliseconds up to a few hundred milliseconds. The in-production testing methodology as described herein is powerful in finding defects which require thousands of iterations of the same data inputs, as well as in identifying devices undergoing degradation. This methodology is also uniquely effective in identifying silicon transition defects.

FIG. 3 is a diagram illustrating an example of a scenario for a SDC testing process 300 for out-of-production devices (i.e., servers) according to one or more examples, with reference to components and features described herein including but not limited to the figures and associated description. The SDC testing process 300 is performed in a networked infrastructure environment such as, e.g., the networked infrastructure environment 100 (FIG. 1, already discussed). Out-of-production testing refers to conducting SDC tests on devices that are idle and not executing production workloads—typically, such devices are entering or undergoing a maintenance phase—while remaining within the networked infrastructure environment. Out-of-production status contrasts with an “offline” status in which a machine is disconnected from the networked infrastructure.

Typically in a large scale infrastructure, there are always sets of servers going through a maintenance phase. Before any maintenance tasks (i.e., maintenance workloads) are started, the production workload is safely migrated off the server, typically referred to as a draining phase. Once a successful drain phase is completed, one or more of maintenance tasks may be performed such as, e.g., the maintenance tasks (e.g., types of maintenance workloads) summarized below.

Firmware Upgrades.

There are numerous devices within a given server and there may be new firmware available on at least one component. These component firmware upgrades are required to keep the fleet up to date for fixing firmware bugs as well as security vulnerabilities.

Kernel Upgrades.

Similar to component level upgrades, the kernel on a particular server is upgraded at a regular cadence, and these provide numerous application and security updates for the entire fleet.

Provisioning.

Provisioning refers to the process of preparing the server for workloads with installation of operating systems, drivers and application-specific recipes. There can also be instances of re-provisioning, where within a dynamic fleet a server is moved from one type of workload to another.

Repair.

Each server that encounters a known fault or triggers a match to a failing signature ends up in a repair queue. Within the repair queue, based on the diagnoses associated with the device, a soft repair (without replacing hardware components) is conducted or a component swap is executed. This enables faulty servers to return back to production.

Once the current maintenance phase workloads are completed for a server, the server is ready to exit the maintenance phase. Any server exiting the maintenance phase can then be undrained to make the server available to perform production workloads.

In accordance with examples, out-of-production testing is integrated with the maintenance phase to perform SDC testing before the server is returned to production status. Out-of-production testing involves the ability to subject servers to known patterns of inputs, and comparison of its expected outputs with known reference values across millions of different execution paths. Tests are executed across different temperatures, voltages, machine types, regions, etc. SDC testing uses patterns and instructions carefully crafted in sequences to match known defects or target a variety of defect families using numerous state search policies within the testing state space. Examples of test families used for out-of-production testing include but are not limited to vector computation tests, cache coherency tests, ASIC correctness tests, and/or floating point based tests, as detailed in Table 1 below:

TABLE 1

| | | | Examples of |
|---|---|---|---|
| | | | optimizations, |
| | Brief description of | How the type of test | customizations, and |
| Test family | test | is used | rotation |
| Vector | Performs basic | Test is cycled at | Customizations can be on |
| Computations | vector computations | minute level | the data type used for |
| tests | like add, subtract, | durations to verify for | instruction, data values |
| | multiply and similar | correctness during | used, operating conditions |
| | arithmetic and | these operations | like frequency or voltage |
| | logical operations | | of testing, and data |
| | | | pattern randomization, |
| | | | and vector width |
| | | | variations |
| Cache | Sibling cores occupy | Test is used to verify | Core pairs under test, type |
| coherency test | similar data | invalidations as well | of exclusivity condition |
| | structures with | as exclusive access | used and the type of |
| | exclusive | for different data | invalidation used. |
| | permissions and then | values within the | |
| | cross cache | cores. Test is used in | |
| | invalidations are | the order of minutes | |
| | checked between | | |
| | contending cores | | |
| ASIC | A known | Test is cycled at | Customizations can be on |
| correctness test | computation is run | minute level | the data type used for |
| | on a given ASIC | durations to verify for | instruction, data values |
| | device and it's | correctness during | used, operating conditions |
| | outputs are verified | these operations; in | like frequency or voltage |
| | against expected | addition values | of testing, and data |
| | values | before and after | pattern randomization, |
| | | computation are | and vector width |
| | | compared for equality | variations |
| Floating Point | Test designed verify | Test used in the order | Customizations can be on |
| based tests | the fault conditions | of minutes, and | the data type used for |
| | for different floating | verifies floating point | instruction, data values |
| | point operations and | calculations | used, operating conditions |
| | approximations | | like frequency or voltage |
| | | | of testing, and data |
| | | | pattern randomization, |
| | | | and vector width |
| | | | variations |

Turning to FIG. 3, a test controller 310 opportunistically identifies servers entering and exiting maintenance states and schedules the servers to undergo silent data corruption testing. In some examples, the test controller 310 corresponds to the test controller 140 (FIG. 1, already discussed). As shown in FIG. 3, servers 320 (including devices 321-324) are exiting production and entering a maintenance phase. Each of the servers 320 is drained at block 330. Based on the time available and the type of server identified, the test controller 310 runs optimized versions of tests (test control, block 312) and provides a snapshot for the device's response to sensitive architectural codepaths, and verifies the computations to be accurate (test results, block 314). A number of server specific parameters are captured at this point to enable understanding of the conditions that result in device failures.

Maintenance tasks (such as the four maintenance tasks described herein, firmware upgrades, kernel upgrades, provisioning, and repair) are performed as out-of-production workflows that are independent complex systems with orchestration across millions of machines. In accordance with examples, the out-of-production test control process enables a seamless methodology to orchestrate silent data corruption tests within a large fleet by integrating with all the maintenance workflows. By coordinating SDC testing with maintenance workloads, this enables minimizing the time spent in drain and undrain phases as well as minimizing disruption to existing workflows with significant time overheads and orchestration complexities. As a result, the out-of-production testing costs are noticeable yet minimal per machine while providing reasonable protection against application corruptions.

For example, as illustrated in FIG. 3 a server 321 that has entered a maintenance phase and has been drained (block 330) is presented for maintenance workloads and SDC testing via one or more test workloads. Maintenance tasks may be presented via a maintenance task queue 316. The test controller 310 coordinates performance of the SDC test workload(s) with the maintenance task workloads. In some examples, the SDC test workloads are integrated with maintenance task workloads according to a set protocol. In some examples the test workload(s) are performed once all of the queued maintenance tasks have been performed. In some examples the test workload(s) are performed before one or more of the queued maintenance tasks have been performed. For example, if one of the queued maintenance tasks is a kernel upgrade, in some examples the test workload(s) are performed before the kernel upgrade maintenance workload is run. In some examples the test workload(s) are performed after some, but not all, of the queued maintenance tasks have been performed. In some examples, performance of some test workload(s) can be interspersed with various of the maintenance workloads in the maintenance task queue 316.

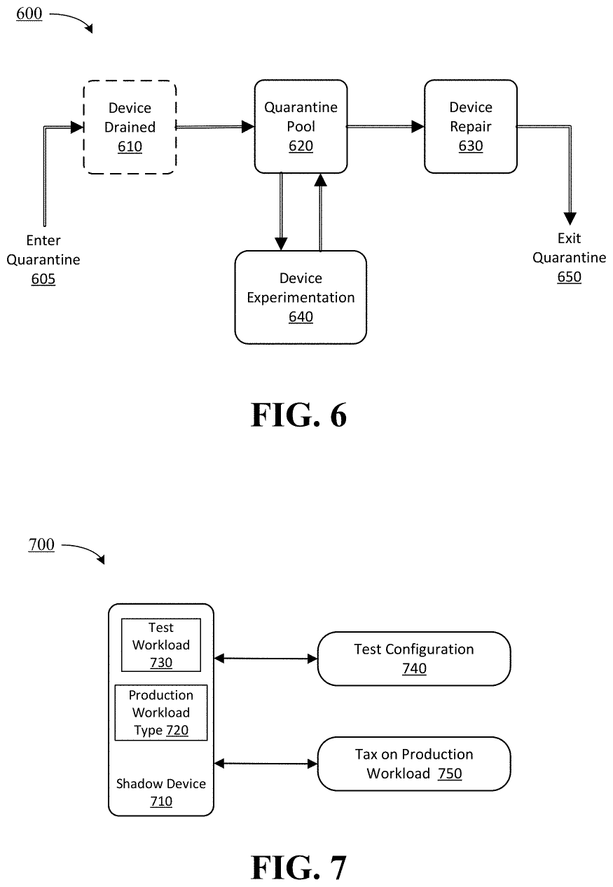

Once SDC test workloads are run, results are captured and evaluated (block 314) by the test controller 310. Any server(s) identified as failing one or more silent data corruption routines (label 340) are routed to a device quarantine (block 350) for further investigation and test refinements. Servers exiting quarantine are undrained at block 360 and return to production status (label 365). Further details regarding a device quarantine pool and process are described herein with reference to FIG. 6.

Once a server completes the scheduled maintenance tasks and passes the SDC tests, the server is undrained (block 360) and then returned to production (label 365). For any given server, the maintenance phase and out-of-production SDC testing can be repeated, for example on a periodic basis.

In some examples, out-of-production testing for SDCs is subject to a subscription process in which servers can be scheduled in advance for exiting production and entry into a maintenance phase. As part of the subscription process, servers can be scheduled for out-of-production SDC testing to occur, as described herein, during the maintenance phase. In some examples, servers scheduled to enter the maintenance phase are also automatically scheduled for SDC testing unless specifically excluded (e.g., by a request or command to exclude from SDC testing).

Some or all aspects of the SDC testing for out-of-production devices as described herein (such as the SDC testing process 300) can be implemented via a test controller (such as the test controller 310) using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the SDC testing process 300 (including the test controller 310) can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the SDC testing process 300 (including operations by the test controller 310) can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

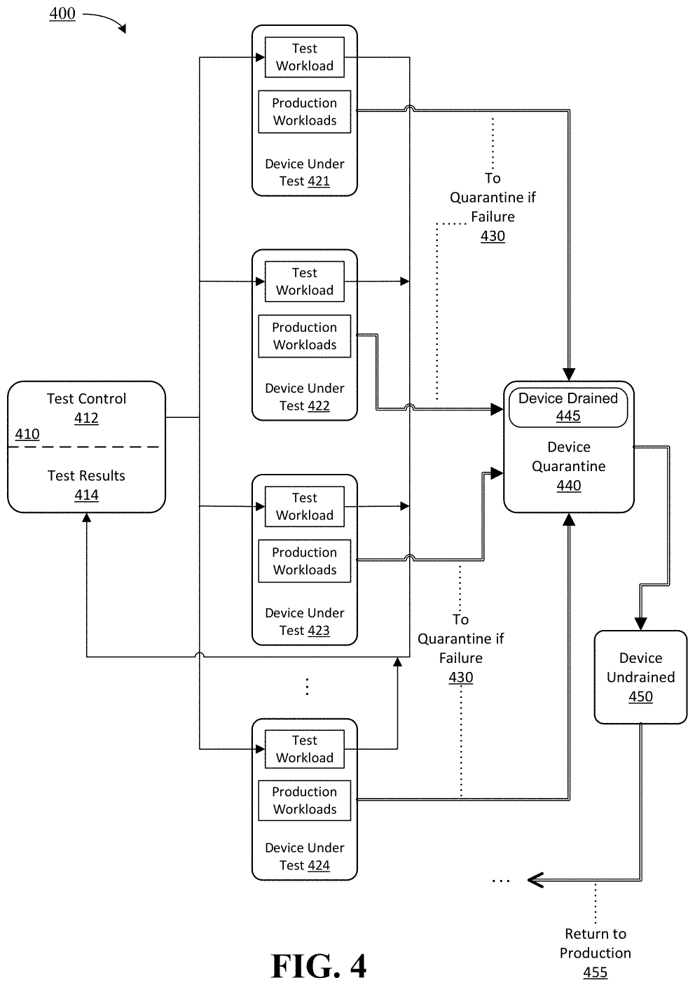

FIG. 4 is a diagram illustrating an example of a scenario for a SDC testing process 400 for in-production devices according to one or more examples, with reference to components and features described herein including but not limited to the figures and associated description. The SDC testing process 400 is performed in a networked infrastructure environment such as, e.g., the networked infrastructure environment 100 (FIG. 1, already discussed). In-production testing refers to conducting SDC tests on devices in the networked infrastructure environment that are actively performing production workloads. In-production SDC testing involves a testing methodology which co-locates the test workload(s) with production workloads, such that test workload(s) are performed while production workloads are running (for example, as executed tasks in parallel). As an example, for a given test workload the test instructions can be executed at millisecond-level intervals while production workloads are also executing.

Like out-of-production testing, in-production testing involves the ability to subject servers to known patterns of inputs, and comparison of its expected outputs with known reference values across millions of different execution paths. Tests are executed across different temperatures, voltages, machine types, regions, etc. SDC testing uses patterns and instructions carefully crafted in sequences to match known defects or target a variety of defect families using numerous state search policies within the testing state space. Examples of test families used for in-production testing include but are not limited to vector computation tests, vector data movement tests, large data gather and scatter tests, power state tracing libraries, and/or data correctness tests, as detailed in Table 2 below:

TABLE 2

| | | | Examples of |
|---|---|---|---|
| | | | optimizations, |
| | Brief description of | How the type of test | customizations, and |
| Test family | test | is used | rotation |
| Vector | Performs basic vector | Test is cycled into | Customizations can be on |
| Computations | computations like | production at milli- | the data type used for |
| tests | add, subtract, | second intervals to | instruction, data values |
| | multiply and similar | verify for correctness | used, operating conditions |
| | arithmetic and logical | during these | like frequency or voltage |
| | operations | operations | of testing, and data |
| | | | pattern randomization, |
| | | | and vector width |
| | | | variations |
| Vector data | Large volumes of | Test is cycled into | Customizations can be on |
| movement | data is either moved | production at milli- | the data type used for |
| tests | from one location to | second intervals to | instruction, data values |
| | another or copied | verify for correctness | used, operating conditions |
| | from one location to | during these | like frequency or voltage |
| | another | operations; in | of testing, and data |
| | | addition values | pattern randomization, |
| | | before and after | and vector width |
| | | moves are compared | variations |
| | | for equality | |
| Large gather | Used to data | Test is cycled into | Customizations can be on |
| and scatter | verification across | production at milli- | the data type used for |
| operations | sparse datasets across | second intervals to | instruction, data values |
| | different memory | verify for correctness | used, operating conditions |
| | locations, in | during these | like frequency or voltage |
| | comparison to | operations; in | of testing, and data |
| | previous test, the data | addition values | pattern randomization, |
| | is spread across a | before and after | and vector width |
| | large range of | moves are compared | variations |
| | addresses | for equality | |
| Power state | Test is used to verify | This test is used to | Sampling interval, |
| tracing | transition to | understand system | tracking period, depth of |
| | appropriate power | behavior under | probing for power and |
| | and performance state | variety of production | performance states |
| | and profile residency | workloads | |

In some examples, tests used for out-of-production are adapted for in-production testing. Before using (for in-production testing) test sequences from out-of-production testing, tests are modified specifically to be conducive to run in short duration testing and co-located with production workloads. This includes fine-tuning of tests along with test coverage tradeoff decisions. In some examples, controls for fine tuning include but are not limited to (1) runtime associated with the test, (2) type of tests being run with respect to instruction families, (3) number of compute cores the test is run on, (4) randomization of seeds tests are run on, (5) number of iterations of the test, (6), how frequently the tests are to be run, etc. Coverage tradeoff impacts include one or more of the following:
(1) Longer runs of the test may increase the search space and the coverage of larger data patterns; however, during in-production testing, this maybe detrimental to the workloads on the machine.
(2) If the tests are run without regard for the type of workload running on the machine—i.e. without an understanding and testing of colocation scenarios, that can potentially hamper application performance; however, running multiple instruction types can increase coverage associated with testing.
(3) Running tests on more cores reduces the number of cores that are completely available for workload, but running on more cores ensures more cores are tested.
(4) Enabling randomized seeding can allow the test to go on random traversal within the test space. This has the potential to increase test coverage while limiting control on the type of test being performed.
(5) The number of iterations allow the tests to be performed multiple times on a given machine; however, running many iterations can be detrimental to the workloads.

In-production testing is live within the entire fleet, and test orchestration for in-production testing is implemented with extreme care as any variation within the test could immediately affect production workloads (e.g., the applications and services being provided to users). Accordingly, testing control provides granular control on test subsets, cores to test, type of workloads to co-locate with as well as in scaling the test up and down to multiple sets of cores based on the workloads. In some examples, shadow testing, as described more fully herein with reference to FIG. 7, is used to test the efficacy and effect of in-production SDC tests before they go live to the fleet.

In some examples, the in-production testing mechanism is always on, such that SDC testing is always occurring somewhere within the fleet. In some examples, in-production testing is provided on a demand basis. The scale at which in-production testing occurs within the fleet is dynamically controlled through testing configurations. In some examples, the SDC test workloads are co-located with production workloads according to test protocols. In some examples, a test subscription list can include but is not limited to the following options: (1) type of server type the test can run on, (2) type of workload that the test can run along with, (3) data-hall, data-center and region within which the test can run, (4) percentage of the fleet the test can run on, (5) type of CPU architecture the test can run on, etc. As one example, the following provides a given vector test definition:

```
vector_test_a is -
  { enabled on type 1 server,
    can run only on shared workloads,
    is eligible for running on data hall 2 in datacenter 3,
    can run only on 40% of the servers matching the above configuration,
    and can only run on architecture a }
```

This example test can be represented in a programming structure as follows:

```
Vector_test_a {
  Exclude = True,
  Server_type: type 1 , excludes = False
  Data Hall: 2, excludes = False,
  Datacenter: 3, excludes = False,
  Percentage: 40%,
  Architecture: CPU Type A
}
```

In some examples, in-production tests are run with particular cadences, such that they are repeated in a server at periodic intervals. For example, some testing can be repeated at intervals such as approximately every X minutes, or every Y hours. In some examples, testing can be repeated at longer intervals such as approximately every Z days, or every W weeks. The repeat interval, or cadence, can depend on factors such as type of test, test duration, test impact (“tax”) on production workloads, and/or other factors.

Turning to FIG. 4, a test controller 410 identifies SDC test workloads to be run across the fleet and schedules the tests to be co-located with production workloads. In some examples, the test controller 410 corresponds to the test controller 140 (FIG. 1, already discussed). Based on test protocols and subscriptions, and the type of machine identified, the test controller 410 runs optimized versions of tests (test control, block 412) and provides a snapshot for the device's response and verifies the computations to be accurate (test results, block 414). As with out-of-production testing, here for in-production testing a number of server specific parameters are captured at this point to enable understanding of the conditions that result in device failures.

In some examples, as illustrated in FIG. 4 SDC tests are submitted for execution across a plurality of devices at the same time. As an example, test workloads are submitted to four devices under test 421-424, are co-located with the production workloads in each server and executed. The number of servers for which a particular test workload is submitted is determined by a scheduler, which submits test workloads at various intervals to groups of servers and can cycle the testing throughout the fleet over a given interval. For example, each server or group of servers can receive a test workload over a particular time slice; the time slice is incremented such that the testing is then provided to a next server or group of servers. The process is repeated such that the test workload “slides” or “rotates” throughout the infrastructure fleet. In some examples, the scheduler also determines a test interval or cadence for particular types of tests.

As SDC test workloads are run, results are captured and evaluated (block 414) by the test controller 410. If a server passes the SDC test, it remains as in-production status and continues performing production workloads. Any server identified as failing the SDC test (label 430) is removed from production status and routed to a device quarantine (block 440) where it is drained (block 445) and evaluated for further investigation and test refinements. Upon exiting the device quarantine, the device is undrained (block 450) and returned to production status (label 455). Further details regarding a quarantine pool and process are described herein with reference to FIG. 6.

Some or all aspects of the SDC testing for in-production devices as described herein (such as the SDC testing process 400) can be implemented via a test controller (such as the test controller 410) using one or more of a CPU, a GPU, an AI accelerator, a FPGA accelerator, an ASIC, and/or via a processor with software, or in a combination of a processor with software and an FPGA or ASIC. More particularly, aspects of the SDC testing process 400 (including the test controller 410) can be implemented in one or more modules as a set of program or logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations of the SDC testing process 400 (including operations by the test controller 410) can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

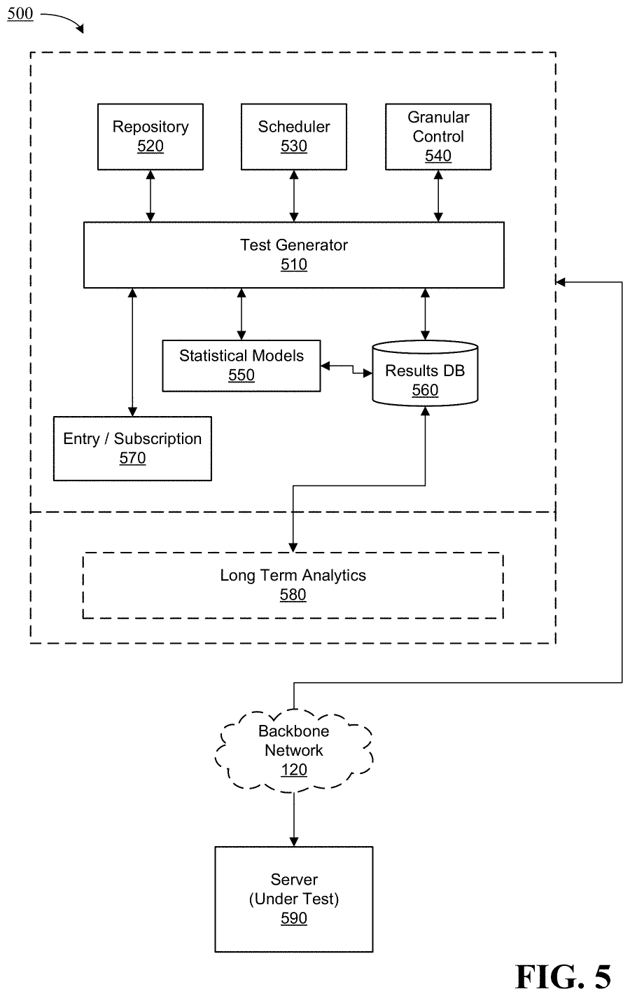

FIG. 5 is a diagram illustrating an example of an architecture for a test controller 500 according to one or more examples, with reference to components and features described herein including but not limited to the figures and associated description. The test controller 500 can be operated within a networked infrastructure environment such as, e.g., the networked infrastructure environment 100 (FIG. 1, already discussed). In some examples, the test controller 500 corresponds to the test controller 140 (FIG. 1, already discussed), to the test controller 310 (FIG. 3, already discussed), and/or to the test controller 410 (FIG. 4, already discussed). In some examples, the test controller 500 includes a test generator 510, a test repository 520, a scheduler 530, a granular control unit 540, a statistical models unit 550, a test results database 560, and/or an entry/subscriptions unit 570. In some examples, the test controller 500 can be specifically configured to operate for SDC testing of servers in one of in-production or out-of-production status; for example, in some examples a separate test controller 500 is used for each of in-production and out-of-production testing.

The test generator 510 operates to generate one or more SDC tests to be scheduled, submitted and executed on one or more fleet servers (such as, e.g., the server 590 under test). The test generator 510 generates one or more SDC tests selected from SDC test routines and test patterns obtained from the test repository 520. In some examples, test selection and generation is based on a SDC testing model. The SDC testing model can include modeling performed by the statistical models unit 550, described further herein. In some examples, the test generation logic for both in-production and out-of-production testing can include one or more of the following considerations: (1) at the time of tool execution, check for subscription definition for a given test within the mode of testing; (2) once the test subscription is verified, a check is made to ensure that the tools required for the test are available on the device under test, (3) pending this verification, test arguments and options are staged to ensure that that the test is run with appropriate configuration, (4) after all these are prepared, the arguments are passed to the test, and (5) the test execution call is made to generate the test(s).

The test repository 520 is a storage library that maintains (e.g., stores) test routines and test patterns used to generate SDC tests, and can include actual test binaries and/or test wrapper scripts associated with the different testing mechanisms. Test routines and test patterns can be based, for example, on testing models such as, e.g., models performed by the statistical model unit 550. Thus, in some examples, within the test repository tests can be executable binaries or scripts calling executable binaries using a desired method. Examples of test repositories can include but are not limited to packaged module flows, large-scale python archive deployments, and git and git like repositories. Examples of tests which are included in this repository can include internally developed tests and vendor provided tests. An example table of tests is provided in Table 3 below:

TABLE 3

| Test Name | Details |
|---|---|
| Cache equivalence test | Test for correctness in data movement |
| | across caches |
| Matrix test | Verify matrix multiplication correctness |
| Floating point test | Verify floating point calculation correctness |
| Vector library | Library of vector based tests |

The scheduler 530 operates to schedule SDC testing on one or more servers in the fleet. Scheduling SDC testing can involve one or more factors such as, for example: the type of SDC test to be run; the duration of the test; the test interval or cadence; the phase or status of the server (e.g., in-production status or out-of-production/maintenance status); the number of servers to be tested within any given time slice or time frame; the nature and type of workloads to be executed (e.g., co-location with production workloads or integration with maintenance workloads). In some examples, the scheduler 530 determines a test interval or cadence based on the particular types of test to be run. For example, a test interval can provide for running the test once every X minutes or once every Y hours on every server within the fleet. As one example, X can be 30 minutes; other intervals in minutes can be used. As another example, Y can be 4 hours; other intervals in hours can be used. In some examples, an option of splicing is used such that at any given point of time, only a certain number of servers can run the test. In some examples, an option is used to influence the test interval by limiting number of servers running the test within a given data center or a workload at any given point of time. In some examples, the test is run once for every upgrade or maintenance type.

In some examples, for in-production testing the scheduler 530 operates to schedule particular SDC tests so that the test workload cycles (e.g., “slides” or “rotates”) throughout the infrastructure fleet. As an example, rotating a test through the fleet can include the following considerations: (1) a test starts on a given specified percentage of the fleet, as allowed by concurrent hosts under testing as per the splicing configuration for milliseconds granularity. (2) Once the test is marked as complete, at the next instance of the scheduler, a completely new set of hosts not previously executing the test within the past X minutes (or so) will now be chosen to run the test. (3) The pattern continues, until the entire fleet is covered within the specified time interval duration. The aggressiveness of the scheduling and batch sizing (number of hosts under test) are both determined by the interval desired for the test.

The granular control unit 540 operates to provide a fine-level of control (e.g., fine-tuning) for SDC testing. For example, the granular control unit 540 determines the test run time, the number of loops and test sequences, and other test configuration parameters. As an example, the granular control unit 540 determines test subsets to run and cores to test, such as selecting test subsets that are suited for co-location with particular types of production workloads. As one example, granular control for a vector library test can include but is not limited to the following options: (1) runtime, (2) cores to run on, (3) seed, (4) subset within vector family, (5) iterations, and/or (6) stop on failure vs continue on failure.

The statistical models unit 550 operates to provide input into test selection, such as, e.g. which tests to run and how often to run particular tests (e.g., test frequency). For example, the statistical models unit 550 can determine, based on testing models, which test routines and test patterns to employ. The statistical models unit 550 makes modifications to test modeling and test selections based on test results collected over time (e.g., from the test results database 560). An example of test modeling result changing the arguments of the test includes conducting and optimizing for a return on test investment metric. The model keeps track of all the test runs within the past, and attempts to suggest an increase of test runtime or decrease of test runtime based on whether increasing or decreasing runtime has had impact in the past collected failure samples. Past failures and time to failure are used to derive future runtimes after confidence is reached from the available samples.

Test results from each server tested are collected and stored in the test results database 560. Determination of whether the result of an individual test is a pass or failure can be performed by the test results database 560 or by other components of the test controller 500. Data regarding the test, server tested, etc. are captured and stored with the results. For example, stored test results data can include, for example, one or more of the following: test identifier, test type, test date and time, test duration, results of test (which can include numeric results, and/or a pass/fail indicator), and/or server-specific parameters captured during the testing process. The data can enable the test controller to identify conditions that result in device failures. The data is also fed to the statistical models unit 550 for use in the test modeling process as described herein.

The entry/subscriptions unit 570 provides test subscription definitions and identifies opportunistic test workload entry points for SDC tests. For example, for out-of-production testing, the entry/subscriptions unit 570 provides scheduling of out-of-production SDC testing to occur for servers exiting production and entering a maintenance phase. In some examples, servers scheduled to enter the maintenance phase are also automatically scheduled for SDC testing unless specifically excluded (e.g., by a request or command to exclude from SDC testing), which can be included in the subscription for that server. In some examples, for out-of-production testing, SDC test workloads are integrated with maintenance task workloads according to a set or defined protocol, which can include an entry point for the SDC test(s) among the scheduled maintenance workloads. Test protocols can be based, e.g., on test type, test duration, maintenance task type, etc. As an example, in some examples the test workload(s) are performed once all of the queued maintenance tasks have been performed. As another example, in some examples the test workload(s) are performed before one or more of the queued maintenance tasks have been performed. For example, if one of the queued maintenance tasks is a kernel upgrade, in some examples the test workload(s) are performed before the kernel upgrade maintenance workload is run. As another example, in some examples the test workload(s) are performed after some, but not all, of the queued maintenance tasks have been performed. In some examples, performance of some test workload(s) can be interspersed with various of the maintenance workloads in a maintenance task queue (such as the maintenance task queue, FIG. 3).

In some examples, for in-production testing the SDC test workloads are co-located with production workloads according to test protocols, as defined by the entry/subscriptions unit 570. In some examples, for in-production testing, test protocols can be based test type, test duration, production workload type, etc. As an example of testing protocols within a production fleet, the testing protocols can provide for the testing to adhere to one or more of the following set of example criteria: (1) tests are to not affect production workloads; (2) tests are to not leave residue on the machine which affects performance after executing the test; (3) tests are not to crash or reboot the machine under test; (4) tests are to have defined exit codes and exception rules for devices under test; and/or (5) tests should not leave memory leaks behind on devices under test.

In some examples, the test controller 500 also includes, or is coupled to or in data communication with, a long-term analytics unit 580. The long-term analytics unit 580 collects test results and associated data from the test results database 560 over an extended time period, which is used to analyze and identify trends. These trends can be used to modify SDC testing.

In some examples, components of the test controller 500 are coupled to or in data communication with one or more of the other components of the test controller 500 via a bus, internal network, or the like. In some examples, components of the test controller 500 are implemented in a computing device (such as, e.g., a server); in some examples, components of the test controller 500 are distributed among a plurality of computing devices. In some examples, the test controller 500 is coupled to or in data communication with one or more servers in the networked infrastructure environment, including fleet servers such as, e.g., a server 590 under test, via the internal network 120 (FIG. 1, already discussed). As described herein, the test controller 500 operates to generate SDC tests (such as, e.g., test instructions or test sequences) and submit tests for execution on one or more devices, such as the server 590 under test. The test controller 500 also collects test results from each server tested. The test results are stored in the test results database 560.

In some examples, the test controller includes additional features and components not specifically shown in FIG. 5 or described herein. In some examples, the test controller includes fewer features and components than shown in FIG. 5 and described herein.

Some or all components in the test controller 500 can be implemented via a test controller (such as the test controller 410) using one or more of a CPU, a GPU, an AI accelerator, a FPGA accelerator, an ASIC, and/or via a processor with software, or in a combination of a processor with software and an FPGA or ASIC. More particularly, components of the test controller 500 can be implemented in one or more modules as a set of program or logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by test controller 500 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

FIG. 6 is a diagram illustrating an example of a quarantine process 600 to investigate and mitigate test failures for in-production devices according to one or more examples, with reference to components and features described herein including but not limited to the figures and associated description. The quarantine process 600 is performed in, or in conjunction with, a networked infrastructure environment such as, e.g., the networked infrastructure environment 100 (FIG. 1, already discussed). In some examples, the quarantine process 600 corresponds to the device quarantine block 350 (FIG. 3, already discussed) and/or to the device quarantine block 440 (FIG. 4, already discussed). A device that fails one or more SDC tests (such as SDC tests conducted as described herein with reference to FIGS. 3-5) enters a quarantine state (label 605). If the device is not already drained (such as, e.g., a device entering quarantine from a production phase) the device is drained at block 610. If the device is already drained (such as, e.g., a device entering quarantine from a maintenance phase), the device can bypass draining at block 610. In each case, the device enters a quarantine pool at block 620.

In the quarantine pool (block 620) the device undergoes investigation to evaluate the source and cause of the SDC test failure, based on test results data for the server (including data such as described herein with reference to the results database 560). If the source and cause of the SDC test failure is determined with high confidence, the device proceeds to device repair at block 630, where failure mitigation (such as, e.g., an appropriate repair to correct for the failure) is conducted. For example, device repair at block 630 can include tasks such as, e.g., replacing a hardware component (such as a processor or a memory device) that was a cause of the SDC test failure. Once the repair is completed, the device exits quarantine at block 650.

If the source and cause of the SDC test failure cannot be determined with high confidence, the server proceeds to device experimentation at block 640, where the device is subjected to further testing and experimentation and additional data is collected. At intervals, the device returns to the quarantine pool (block 620) and the evaluation for the source and cause of the SDC test failure is repeated. If the source and cause of the SDC test failure is now determined with high confidence, the device proceeds to device repair (block 630) as described above. If the source and cause of the SDC test failure cannot be determined with high confidence, the device returns to device experimentation (block 640), for further testing and experimentation. In some instances, multiple cycles between the quarantine pool (block 620) and device experimentation (block 640) may be required for a given server.

Some or all aspects of the quarantine processes as described herein (such as the quarantine process 600) can be implemented via a test controller (such as the test controller 410) using one or more of a CPU, a GPU, an AI accelerator, a FPGA accelerator, an ASIC, and/or via a processor with software, or in a combination of a processor with software and an FPGA or ASIC. More particularly, aspects of the quarantine process 600 can be implemented in one or more modules as a set of program or logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations of the quarantine process 600 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

FIG. 7 is a diagram illustrating an example of a shadow test process 700 according to one or more examples, with reference to components and features described herein including but not limited to the figures and associated description. The shadow test process 700 is performed in, or in conjunction with, a networked infrastructure environment such as, e.g., the networked infrastructure environment 100 (FIG. 1, already discussed). Shadow testing involves running a wide variety of workloads with A/B testing, for different proposed SDC test instruction sequences with different seasonality and across different workloads. The shadow testing is designed to check and determine if the proposed SDC testing would result in significant negative impacts, such as, for example, performance anomalies in the workload or other performance decreases in the fleet. Thus, for example, the shadow testing can help identify any defects in the proposed SDC testing methodologies or assumptions before the SDC test is launched live into the fleet. Based on the scaling of the production workload, the testing mechanism can be subject to descale, in accordance with a scaling factor determined through an evaluation process for each type of workload. For example, a shadow testing device 710 is used for testing and evaluating proposed SDC tests with various types of production workloads. The shadow testing device 710 can be, for example, a server of a same or similar type and buildout as used in the fleet. The shadow testing device 710 executes a production workload type 720. At the same time, a proposed SDC test workload 730 is introduced and run on the shadow testing device 710. Test configurations are modified, based on the A/B testing, to obtain optimal sequences and scheduling controls (block 740).

As part of the shadow testing process, a co-location study is performed to determine a footprint tax for the proposed SDC test (block 750). The footprint tax provides a metric to show the impact of executing the proposed SDC test when co-located (e.g., executed in parallel) with a particular production workload type; that is, the footprint tax shows the pressure that the proposed SDC test imposes on the production workload type when co-located with that workload. Proposed SDC tests are designed and modified such that the footprint tax for the test is reduced below a tax threshold for the workload type. With repeated sets of experimentation, control structures and safeguards are established for enabling different options for different workloads. Once shadow testing shows the safety and efficacy of a given proposed SDC test (e.g., the proposed SDC test passes shadow testing), the proposed SDC test is then scaled for submission to the entire fleet. In some examples, a proposed SDC test that passes shadow testing is provided to a test repository (e.g., the repository 520, FIG. 5) for use in generating SDC tests.

Some or all aspects of the shadow testing processes as described herein (such as the shadow test process 700) can be implemented via a computing system (which, in some examples, can include a test controller such as the test controller 500 in FIG. 5) using one or more of a CPU, a GPU, an AI accelerator, a FPGA accelerator, an ASIC, and/or via a processor with software, or in a combination of a processor with software and an FPGA or ASIC. More particularly, aspects of the shadow test process 700 can be implemented in one or more modules as a set of program or logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations of the shadow test process 700 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

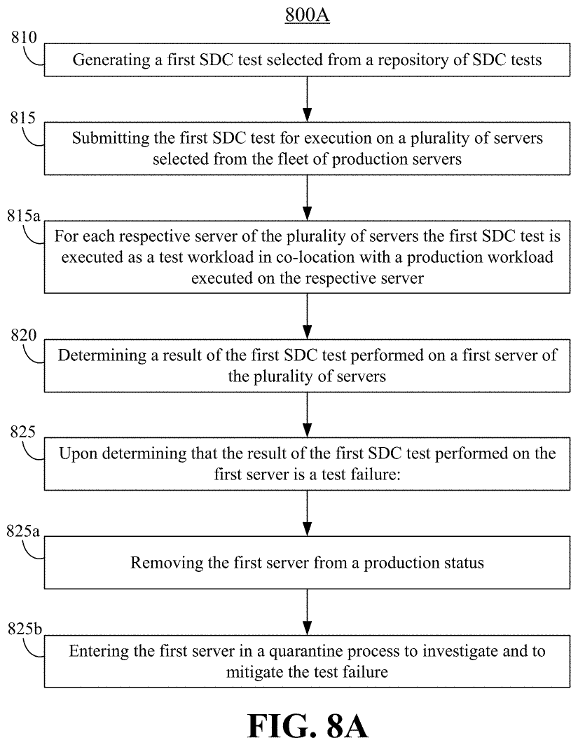

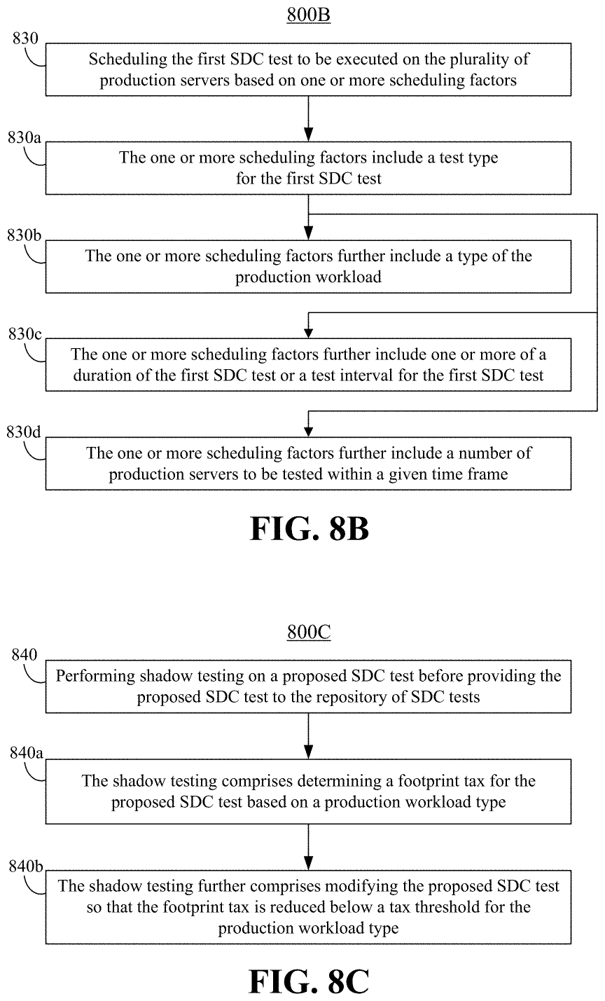

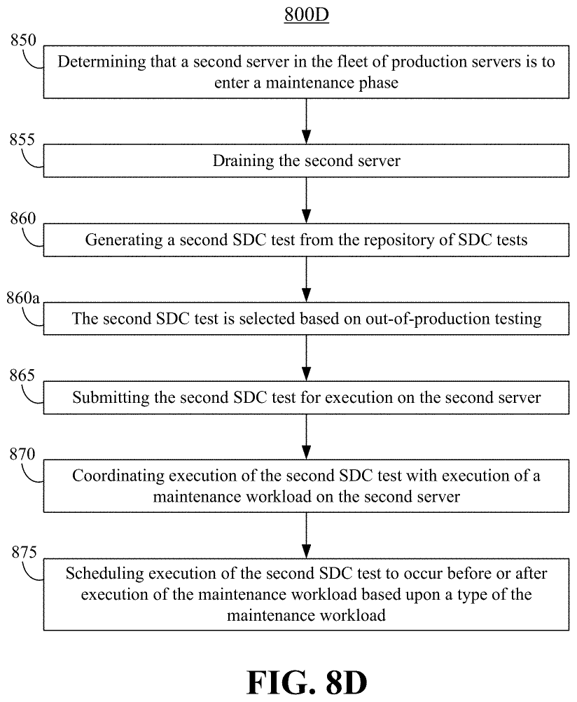

FIGS. 8A-8D provide flow charts illustrating an example method 800 (including process components 800A, 800B, 800C and 800D) of conducting silent data corruption (SDC) testing according to one or more examples, with reference to components and features described herein including but not limited to the figures and associated description. The method 800 is generally performed within a networked infrastructure environment including a fleet of servers, such as, for example, the networked infrastructure environment 100 (FIG. 1, already discussed). The method 800 (or at least aspects thereof) can generally be implemented in the test controller 140 (FIG. 1, already discussed), the test controller 310 (FIG. 3, already discussed), the test controller 410 (FIG. 4, already discussed), and/or the test controller 500 (FIG. 5, already discussed).

In some examples, some or all aspects of the method 800 can be implemented via a test controller (such as the test controller 410) using one or more of a CPU, a GPU, an AI accelerator, a FPGA accelerator, an ASIC, and/or via a processor with software, or in a combination of a processor with software and an FPGA or ASIC. More particularly, aspects of the method 800 can be implemented in one or more modules as a set of program or logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations of the method 800 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

Turning to FIG. 8A, the method 800A begins at illustrated processing block 810 by generating a first SDC test selected from a repository of SDC tests. Illustrated processing block 815 provides for submitting the first SDC test for execution on a plurality of servers selected from the fleet of production servers, where at block 815a, for each respective server of the plurality of servers the first SDC test is executed as a test workload in co-location with a production workload executed on the respective server. Illustrated processing block 820 provides for determining a result of the first SDC test performed on a first server of the plurality of servers. Illustrated processing block 825 provides for upon determining that the result of the first SDC test performed on the first server is a test failure, removing the first server from a production status at block 825a, and entering the first server in a quarantine process to investigate and to mitigate the test failure at block 825b. In some examples, the first SDC test is generated (block 810) based on a SDC testing model.

Turning now to FIG. 8B, the method 800B provides for, at illustrated processing block 830, scheduling the first SDC test to be executed on the plurality of production servers based on one or more scheduling factors, where at block 830a the one or more scheduling factors include a test type for the first SDC test. At block 830b, the one or more scheduling factors further include a type of the production workload. At block 830c, the one or more scheduling factors further include one or more of a duration of the first SDC test or a test interval for the first SDC test. At block 830d, the one or more scheduling factors further include a number of production servers to be tested within a given time frame.

Turning now to FIG. 8C, the method 800C provides for, at illustrated processing block 840, performing shadow testing on a proposed SDC test before providing the proposed SDC test to the repository of SDC tests. At block 840a, the shadow testing comprises determining a footprint tax for the proposed SDC test based on a production workload type. At block 840b, the shadow testing further comprises modifying the proposed SDC test so that the footprint tax is reduced below a tax threshold for the production workload type.

Turning now to FIG. 8D, the method 800D provides for, at illustrated processing block 850, determining that a second server in the fleet of production servers is to enter a maintenance phase. Illustrated processing block 855 provides for draining the second server. Illustrated processing block 860 provides for generating a second SDC test from the repository of SDC tests, where at block 860a the second SDC test is selected based on out-of-production testing. Illustrated processing block 865 provides for submitting the second SDC test for execution on the second server. Illustrated processing block 870 provides for coordinating execution of the second SDC test with execution of a maintenance workload on the second server. In some examples, coordinating execution of the second SDC test with execution of the maintenance workload includes, at block 875, scheduling execution of the second SDC test to occur before or after execution of the maintenance workload based upon a type of the maintenance workload.

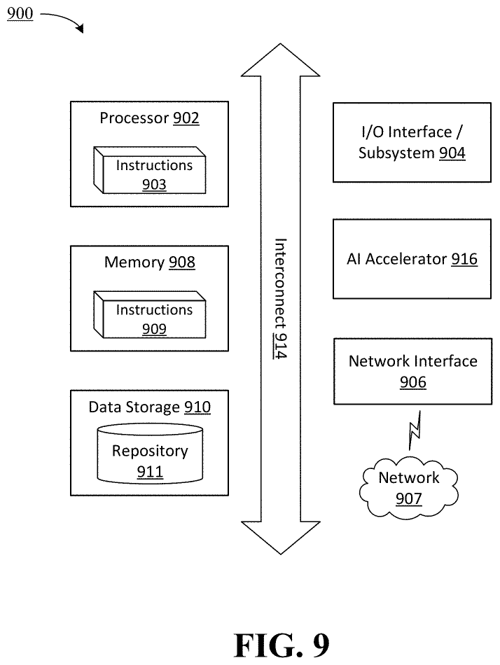

FIG. 9 is a block diagram illustrating an example of an architecture for a computing system 900 for use in a silent data corruption detection system according to one or more examples, with reference to components and features described herein including but not limited to the figures and associated description. In some examples, the computing system 900 can be used to implement any of the devices or components described herein, including the test controller 140 (FIG. 1), the test controller 310 (FIG. 3), the test controller 410 (FIG. 4), the test controller 500 (FIG. 5), and/or any other components of the networked infrastructure environment 100 (FIG. 1). In some examples, the computing system 900 can be used to implement any of the processes described herein including the SDC testing process 300 (FIG. 3), the SDC testing process 400 (FIG. 4), the quarantine process 600 (FIG. 6), the shadow test process 700 (FIG. 7), and/or the method 800 (FIGS. 8A-8D). The computing system 900 includes one or more processors 902, an input-output (I/O) interface/subsystem 904, a network interface 906, a memory 908, and a data storage 910. These components are coupled or connected via an interconnect 914. Although FIG. 9 illustrates certain components, the computing system 900 can include additional or multiple components coupled or connected in various ways. It is understood that not all examples will necessarily include every component shown in FIG. 9.

The processor 902 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 902 can include, or be connected to, a memory (such as, e.g., the memory 908) storing executable instructions 909 and/or data, as necessary or appropriate. The processor 902 can execute such instructions to implement, control, operate or interface with any devices, components, features or methods described herein with reference to FIGS. 1, 3, 4, 5, 6, 7, and 8A-8D. The processor 902 can communicate, send, or receive messages, requests, notifications, data, etc. to/from other devices. The processor 902 can be embodied as any type of processor capable of performing the functions described herein. For example, the processor 902 can be embodied as a single or multi-core processor(s), a digital signal processor, a microcontroller, or other processor or processing/controlling circuit. The processor can include embedded instructions 903 (e.g., processor code).

The I/O interface/subsystem 904 can include circuitry and/or components suitable to facilitate input/output operations with the processor 902, the memory 908, and other components of the computing system 900. The I/O interface/subsystem 904 can include a user interface including code to present, on a display, information or screens for a user and to receive input (including commands) from a user via an input device (e.g., keyboard or a touch-screen device).

The network interface 906 can include suitable logic, circuitry, and/or interfaces that transmits and receives data over one or more communication networks using one or more communication network protocols. The network interface 906 can operate under the control of the processor 902, and can transmit/receive various requests and messages to/from one or more other devices (such as, e.g., any one or more of the devices illustrated in FIGS. 1, 3, 4, 5, 6, and 7. The network interface 906 can include wired or wireless data communication capability; these capabilities can support data communication with a wired or wireless communication network, such as the network 907, the external network 50 (FIG. 1, already discussed), the internal network 120 (FIG. 1, already discussed), and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a Wi-Fi network or corporate LAN). The network interface 906 can support communication via a short-range wireless communication field, such as Bluetooth, NFC, or RFID. Examples of network interface 906 can include, but are not limited to, an antenna, a radio frequency transceiver, a wireless transceiver, a Bluetooth transceiver, an ethernet port, a universal serial bus (USB) port, or any other device configured to transmit and receive data.

The memory 908 can include suitable logic, circuitry, and/or interfaces to store executable instructions and/or data, as necessary or appropriate, when executed, to implement, control, operate or interface with any devices, components, features or methods described herein with reference to FIGS. 1, 3, 4, 5, 6, 7, and 8A-8D. The memory 908 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 908 can store various data and software used during operation of the computing system 900 such as operating systems, applications, programs, libraries, and drivers. The memory 908 can be communicatively coupled to the processor 902 directly or via the I/O subsystem 904. In use, the memory 908 can contain, among other things, a set of machine instructions 909 which, when executed by the processor 902, causes the processor 902 to perform operations to implement examples of the present disclosure.

The data storage 910 can include any type of device or devices configured for short-term or long-term storage of data such as, for example, memory devices and circuits, memory cards, hard disk drives, solid-state drives, non-volatile flash memory, or other data storage devices. The data storage 910 can include or be configured as a database, such as a relational or non-relational database, or a combination of more than one database. In some examples, a database or other data storage can be physically separate and/or remote from the computing system 900, and/or can be located in another computing device, a database server, on a cloud-based platform, or in any storage device that is in data communication with the computing system 900. In some examples, the data storage 910 includes a data repository 911, which in some examples can include data for a specific application. In some examples, the data repository 911 corresponds to the test repository 520 (FIG. 5, already discussed).

The interconnect 914 can include any one or more separate physical buses, point to point connections, or both connected by appropriate bridges, adapters, or controllers. The interconnect 914 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 900.

In some examples, the computing system 900 also includes an accelerator, such as an artificial intelligence (AI) accelerator 916. The AI accelerator 916 includes suitable logic, circuitry, and/or interfaces to accelerate artificial intelligence applications, such as, e.g., artificial neural networks, machine vision and machine learning applications, including through parallel processing techniques. In one or more examples, the AI accelerator 916 can include hardware logic or devices such as, e.g., a graphics processing unit (GPU) or an FPGA. The AI accelerator 916 can implement one or more devices, components, features or methods described herein with reference to FIGS. 1, 3, 4, 5, 6, 7, and 8A-8D.

In some examples, the computing system 900 also includes a display (not shown in FIG. 9). In some examples, the computing system 900 also interfaces with a separate display such as, e.g., a display installed in another connected device (not shown in FIG. 9). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some examples, the display can include a display interface for communicating with a display external to the computing system 900.

In some examples, one or more of the illustrative components of the computing system 900 can be incorporated (in whole or in part) within, or otherwise form a portion of, another component. For example, the memory 908, or portions thereof, can be incorporated within the processor 902. As another example, the I/O interface/subsystem 904 can be incorporated within the processor 902 and/or code (e.g., instructions 909) in the memory 908. In some examples, the computing system 900 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some examples, the computing system 900, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Examples of each of the above systems, devices, components and/or methods, including the networked infrastructure environment 100, the test controller 140, the SDC testing process 300, the test controller 310, the SDC testing process 400, the test controller 410, the test controller 500, the quarantine process 600, the shadow test process 700, and/or the method 800, and/or any other system, devices, components, or methods can be implemented in hardware, software, or any suitable combination thereof. For example, implementations can be made using one or more of a CPU, a GPU, an AI accelerator, a FPGA accelerator, an ASIC, and/or via a processor with software, or in a combination of a processor with software and an FPGA or ASIC, and/or in one or more modules as a set of program or logic instructions stored in a machine- or computer-readable storage medium such as RAM, ROM, PROM, firmware, flash memory, etc. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### ADDITIONAL NOTES AND EXAMPLES

Example 1 includes a computer-implemented method of conducting silent data corruption (SDC) testing, in a network comprising a test controller and a fleet of production servers, comprising generating a first SDC test selected from a repository of SDC tests, submitting the first SDC test for execution on a plurality of servers selected from the fleet of production servers, wherein for each respective server of the plurality of servers the first SDC test is executed as a test workload in co-location with a production workload executed on the respective server, determining a result of the first SDC test performed on a first server of the plurality of servers, and upon determining that the result of the first SDC test performed on the first server is a test failure, removing the first server from a production status, and entering the first server in a quarantine process to investigate and to mitigate the test failure.
Example 2 includes the method of Example 1, wherein the first SDC test is generated based on a SDC testing model.
Example 3 includes the method of Example 1 or 2, further comprising scheduling the first SDC test to be executed on the plurality of servers based on one or more scheduling factors, wherein the one or more scheduling factors include a test type for the first SDC test.
Example 4 includes the method of Example 1, 2, or 3, wherein the one or more scheduling factors further include a type of the production workload.
Example 5 includes the method of any of Examples 1-4, wherein the one or more scheduling factors further include one or more of a duration of the first SDC test or a test interval for the first SDC test.
Example 6 includes the method of any of Examples 1-5, wherein the one or more scheduling factors further include a number of servers to be tested within a given time frame.
Example 7 includes the method of any of Examples 1-6, wherein to mitigate the test failure includes to conduct a repair of a component of the first server determined to be a cause of the failure.
Example 8 includes the method of any of Examples 1-7, further comprising performing shadow testing on a proposed SDC test before providing the proposed SDC test to the repository of SDC tests.
Example 9 includes the method of any of Examples 1-8, wherein the shadow testing comprises determining a footprint tax for the proposed SDC test based on a production workload type.
Example 10 includes the method of any of Examples 1-9, wherein the shadow testing further comprises modifying the proposed SDC test so that the footprint tax is reduced below a tax threshold for the production workload type.
Example 11 includes the method of any of Examples 1-10, further comprising determining that a second server in the fleet of production servers is to enter a maintenance phase, draining the second server, generating a second SDC test from the repository of SDC tests, wherein the second SDC test is selected based on out-of-production testing, submitting the second SDC test for execution on the second server, and coordinating execution of the second SDC test with execution of a maintenance workload on the second server.
Example 12 includes the method of any of Examples 1-11, wherein coordinating execution of the second SDC test with execution of the maintenance workload includes scheduling execution of the second SDC test to occur before or after execution of the maintenance workload based upon a type of the maintenance workload.
Example 13 includes at least one computer readable storage medium comprising a set of instructions which, when executed by a computing device in a network including a fleet of production servers, cause the computing device to perform operations comprising generating a first silent data corruption (SDC) test selected from a repository of SDC tests, submitting the first SDC test for execution on a plurality of servers selected from the fleet of production servers, wherein for each respective server of the plurality of servers the first SDC test is executed as a test workload in co-location with a production workload executed on the respective server, determining a result of the first SDC test performed on a first server of the plurality of servers, and upon determining that the result of the first SDC test performed on the first server is a test failure, removing the first server from a production status, and entering the first server in a quarantine process to investigate and to mitigate the test failure.
Example 14 includes the at least one computer readable storage medium of Example 13, wherein the instructions, when executed, further cause the computing device to perform operations comprising scheduling the first SDC test to be executed on the plurality of servers based on one or more scheduling factors, wherein the one or more scheduling factors include a test type for the first SDC test and one or more of a type of the production workload, a duration of the first SDC test, a test interval for the first SDC test, or a number of servers to be tested within a given time frame.
Example 15 includes the at least one computer readable storage medium of Example 13 or 14, wherein the instructions, when executed, further cause the computing device to perform shadow testing on a proposed SDC test before providing the proposed SDC test to the repository of SDC tests, wherein the shadow testing comprises determining a footprint tax for the proposed SDC test based on a production workload type and modifying the proposed SDC test so that the footprint tax is reduced below a tax threshold for the production workload type.
Example 16 includes the at least one computer readable storage medium of Example 13, 14, or 15, wherein the instructions, when executed, further cause the computing device to perform operations comprising determining that a second server in the fleet of production servers is to enter a maintenance phase, draining the second server, generating a second SDC test from the repository of SDC tests, wherein the second SDC test is selected based on out-of-production testing, submitting the second SDC test for execution on the second server, and coordinating execution of the second SDC test with execution of a maintenance workload on the second server, wherein coordinating execution of the second SDC test with execution of the maintenance workload includes scheduling execution of the second SDC test to occur before or after execution of the maintenance workload based upon a type of the maintenance workload.
Example 17 includes a computing system configured for operation in a network including a fleet of production servers, the computing system comprising a processor, and a memory coupled to the processor, the memory comprising instructions which, when executed by the processor, cause the computing system to perform operations comprising generating a first silent data corruption (SDC) test selected from a repository of SDC tests, submitting the first SDC test for execution on a plurality of servers selected from the fleet of production servers, wherein for each respective server of the plurality of servers the first SDC test is executed as a test workload in co-location with a production workload executed on the respective server, determining a result of the first SDC test performed on a first server of the plurality of servers, and upon determining that the result of the first SDC test performed on the first server is a test failure, removing the first server from a production status, and entering the first server in a quarantine process to investigate and to mitigate the test failure.
Example 18 includes the system of Example 17, wherein the instructions, when executed, further cause the computing system to perform operations comprising scheduling the first SDC test to be executed on the plurality of servers based on one or more scheduling factors, wherein the one or more scheduling factors include a test type for the first SDC test and one or more of a type of the production workload, a duration of the first SDC test, a test interval for the first SDC test, or a number of servers to be tested within a given time frame.
Example 19 includes the system of Example 17 or 18, wherein the instructions, when executed, further cause the computing system to perform shadow testing on a proposed SDC test before providing the proposed SDC test to the repository of SDC tests, wherein the shadow testing comprises determining a footprint tax for the proposed SDC test based on a production workload type and modifying the proposed SDC test so that the footprint tax is reduced below a tax threshold for the production workload type.
Example 20 includes the system of Example 17, 18, or 19, wherein the instructions, when executed, further cause the computing system to perform operations comprising determining that a second server in the fleet of production servers is to enter a maintenance phase, draining the second server, generating a second SDC test from the repository of SDC tests, wherein the second SDC test is selected based on out-of-production testing, submitting the second SDC test for execution on the second server, and coordinating execution of the second SDC test with execution of a maintenance workload on the second server, wherein coordinating execution of the second SDC test with execution of the maintenance workload includes scheduling execution of the second SDC test to occur before or after execution of the maintenance workload based upon a type of the maintenance workload.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the platform within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

What is claimed is:

1. In a network comprising a test controller and a fleet of production servers, a computer-implemented method of conducting silent data corruption (SDC) testing comprising:
generating a first SDC test selected from a repository of SDC tests;
submitting the first SDC test for execution on a plurality of servers selected from the fleet of production servers, wherein for each respective server of the plurality of servers the first SDC test is executed as a test workload in co-location with a production workload executed on the respective server;
determining a result of the first SDC test performed on a first server of the plurality of servers; and
upon determining that the result of the first SDC test performed on the first server is a test failure:
removing the first server from a production status; and
entering the first server in a quarantine process to investigate and to mitigate the test failure.

2. The method of claim 1, wherein the first SDC test is generated based on a SDC testing model.

3. The method of claim 1, further comprising scheduling the first SDC test to be executed on the plurality of servers based on one or more scheduling factors, wherein the one or more scheduling factors include a test type for the first SDC test.

4. The method of claim 3, wherein the one or more scheduling factors further include a type of the production workload.

5. The method of claim 3, wherein the one or more scheduling factors further include one or more of a duration of the first SDC test or a test interval for the first SDC test.

6. The method of claim 3, wherein the one or more scheduling factors further include a number of servers to be tested within a given time frame.

7. The method of claim 1, wherein to mitigate the test failure includes to conduct a repair of a component of the first server determined to be a cause of the failure.

8. The method of claim 1, further comprising performing shadow testing on a proposed SDC test before providing the proposed SDC test to the repository of SDC tests.

9. The method of claim 8, wherein the shadow testing comprises determining a footprint tax for the proposed SDC test based on a production workload type.

10. The method of claim 9, wherein the shadow testing further comprises modifying the proposed SDC test so that the footprint tax is reduced below a tax threshold for the production workload type.

11. The method of claim 1, further comprising:
determining that a second server in the fleet of production servers is to enter a maintenance phase;
draining the second server;
generating a second SDC test from the repository of SDC tests, wherein the second SDC test is selected based on out-of-production testing;
submitting the second SDC test for execution on the second server; and
coordinating execution of the second SDC test with execution of a maintenance workload on the second server.

12. The method of claim 11, wherein coordinating execution of the second SDC test with execution of the maintenance workload includes scheduling execution of the second SDC test to occur before or after execution of the maintenance workload based upon a type of the maintenance workload.

13. At least one computer readable storage medium comprising a set of instructions which, when executed by a computing device in a network including a fleet of production servers, cause the computing device to perform operations comprising:
generating a first silent data corruption (SDC) test selected from a repository of SDC tests;
submitting the first SDC test for execution on a plurality of servers selected from the fleet of production servers, wherein for each respective server of the plurality of servers the first SDC test is executed as a test workload in co-location with a production workload executed on the respective server;
determining a result of the first SDC test performed on a first server of the plurality of servers; and
upon determining that the result of the first SDC test performed on the first server is a test failure:
removing the first server from a production status; and
entering the first server in a quarantine process to investigate and to mitigate the test failure.

14. The at least one computer readable storage medium of claim 13, wherein the instructions, when executed, further cause the computing device to perform operations comprising scheduling the first SDC test to be executed on the plurality of servers based on one or more scheduling factors, wherein the one or more scheduling factors include a test type for the first SDC test and one or more of a type of the production workload, a duration of the first SDC test, a test interval for the first SDC test, or a number of servers to be tested within a given time frame.

15. The at least one computer readable storage medium of claim 13, wherein the instructions, when executed, further cause the computing device to perform shadow testing on a proposed SDC test before providing the proposed SDC test to the repository of SDC tests, wherein the shadow testing comprises determining a footprint tax for the proposed SDC test based on a production workload type and modifying the proposed SDC test so that the footprint tax is reduced below a tax threshold for the production workload type.

16. The at least one computer readable storage medium of claim 13, wherein the instructions, when executed, further cause the computing device to perform operations comprising:
determining that a second server in the fleet of production servers is to enter a maintenance phase;
draining the second server;
generating a second SDC test from the repository of SDC tests, wherein the second SDC test is selected based on out-of-production testing;
submitting the second SDC test for execution on the second server; and
coordinating execution of the second SDC test with execution of a maintenance workload on the second server,
wherein coordinating execution of the second SDC test with execution of the maintenance workload includes scheduling execution of the second SDC test to occur before or after execution of the maintenance workload based upon a type of the maintenance workload.

17. A computing system configured for operation in a network including a fleet of production servers, the computing system comprising:
a processor; and
a memory coupled to the processor, the memory comprising instructions which, when executed by the processor, cause the computing system to perform operations comprising:
generating a first silent data corruption (SDC) test selected from a repository of SDC tests;
submitting the first SDC test for execution on a plurality of servers selected from the fleet of production servers, wherein for each respective server of the plurality of servers the first SDC test is executed as a test workload in co-location with a production workload executed on the respective server;
determining a result of the first SDC test performed on a first server of the plurality of servers; and
upon determining that the result of the first SDC test performed on the first server is a test failure:
removing the first server from a production status; and
entering the first server in a quarantine process to investigate and to mitigate the test failure.

18. The computing system of claim 17, wherein the instructions, when executed, further cause the computing system to perform operations comprising scheduling the first SDC test to be executed on the plurality of servers based on one or more scheduling factors, wherein the one or more scheduling factors include a test type for the first SDC test and one or more of a type of the production workload, a duration of the first SDC test, a test interval for the first SDC test, or a number of servers to be tested within a given time frame.

19. The computing system of claim 17, wherein the instructions, when executed, further cause the computing system to perform shadow testing on a proposed SDC test before providing the proposed SDC test to the repository of SDC tests, wherein the shadow testing comprises determining a footprint tax for the proposed SDC test based on a production workload type and modifying the proposed SDC test so that the footprint tax is reduced below a tax threshold for the production workload type.

20. The computing system of claim 17, wherein the instructions, when executed, further cause the computing system to perform operations comprising:
determining that a second server in the fleet of production servers is to enter a maintenance phase;
draining the second server;
generating a second SDC test from the repository of SDC tests, wherein the second SDC test is selected based on out-of-production testing;
submitting the second SDC test for execution on the second server; and
coordinating execution of the second SDC test with execution of a maintenance workload on the second server,
wherein coordinating execution of the second SDC test with execution of the maintenance workload includes scheduling execution of the second SDC test to occur before or after execution of the maintenance workload based upon a type of the maintenance workload.
